(19) United States
(12) Patent Application Publication
(10) Pub. No.: US 2008/0032797 A1
(43) Pub. Date: Feb. 7, 2008

(54) Combining broadcast sporting events and computer-based gaming

(75) Inventors: Tom Harris, Jerusalem (IL); Carmi Bogot, Maaleh Adumim (IL)

Correspondence Address: WELSH & KATZ, LTD, 120 S RIVERSIDE PLAZA, 22ND FLOOR, CHICAGO, IL, 60606, US

(73) Assignee: NDS Limited, West Drayton (GB)

(21) Appl. No.: 11/498,484

(22) Filed: Aug. 3, 2006

Related U.S. Application Data
(60) Provisional application No. 60/820,143, filed on Jul. 24, 2006.

(51) Int. Cl. A63F 13/00

(52) U.S. Cl. 463/40

(57) ABSTRACT

A system and method for extending a broadcast game into a viewer-played game, including a) providing a broadcast game to a viewer, b) receiving an instruction from the viewer during the broadcast to provide a simulation of the broadcast game, and c) providing a viewer-played game to the viewer, where the viewer-played game provides interactive game play within the simulation.

The present application claims the benefit of the filing date of provisional application No. 60/820,143 filed on 31 Jul. 2006.

### FIELD OF THE INVENTION

The present invention relates to computer-based gaming in general, and more particularly to combining broadcast game play and computer-based gaming.

### BACKGROUND OF THE INVENTION

Computer-based games that simulate professional sporting events, such as football or basketball, are increasingly competing with broadcast sporting events for the viewer's time and attention. While some attempts have been made to stem this tide, such as by providing viewers with viewer-controlled camera angles of broadcast sporting events, the growing interest in sports simulation games and fantasy leagues indicate that sports fans desire a greater level of immersion and active participation in sporting events.

### SUMMARY OF THE INVENTION

The present invention in certain embodiments thereof seeks to provide a system and method for combining broadcast sporting events and computer-based gaming, thereby providing viewers with a computer-based gaming experience within the context of a broadcast sporting event.

In another aspect of the present invention a method is provided for extending a broadcast game into a viewer-played game, the method including a) providing a broadcast game to a viewer, b) receiving an instruction from the viewer during the broadcast to provide a simulation of the broadcast game, and c) providing a viewer-played game to the viewer, where the viewer-played game provides interactive game play within the simulation.

In another aspect of the present invention the providing of the viewer played game includes providing a simulation of the broadcast game that incorporates at least one characteristic of the broadcast game, thereby creating a continuation of the broadcast game.

In another aspect of the present invention the method further includes announcing the availability of the viewer-played game play in connection with the broadcast game.

In another aspect of the present invention the method further includes accepting payment from the viewer in connection with the viewer-played game.

In another aspect of the present invention the simulation has an initial state, where the initial state is based on a previous state of the broadcast game.

In another aspect of the present invention the simulation has an initial state, where the initial state is based on a current state of the broadcast game.

In another aspect of the present invention the method further includes suspending the providing of the broadcast game upon the providing of the viewer-played game, and resuming the providing of the broadcast game upon cessation of the viewer-played game.

In another aspect of the present invention the providing of the viewer played game includes providing the viewer-played game for a period of time generally equal to the time elapsed between a time corresponding to the previous state and a time during the broadcast when the instruction was received.

In another aspect of the present invention the method further includes interrupting the broadcast game during the viewer-played game, buffering the broadcast game from the point of interruption, and resuming the broadcast game from the point of interruption upon cessation of the viewer-played game.

In another aspect of the present invention the providing the broadcast game and the providing the viewer-played game comprise providing the broadcast game and the viewer-played game simultaneously.

In another aspect of the present invention the method further includes selectably switching between the broadcast game and the viewer-played game.

In another aspect of the present invention the method further includes receiving a signal from the viewer requesting the switching.

In another aspect of the present invention the method further includes initializing the simulation from parameters of the broadcast game, where the parameters are derived from a digital broadcast stream carrying the broadcast game.

In another aspect of the present invention the method further includes modifying a simulation parameter of the viewer-played game responsive to a modification of a corresponding real parameter of the broadcast game.

In another aspect of the present invention the method further includes determining when to modify the simulation parameter of the viewer-played game.

In another aspect of the present invention the method further includes receiving a signal from the viewer indicating when to modify the simulation parameter of the viewer-played game.

In another aspect of the present invention the method further includes substituting a simulation parameter of the viewer-played game corresponding to a real parameter of the broadcast game with a different simulation parameter not corresponding to a real parameter of the broadcast game.

In another aspect of the present invention the method further includes receiving an instruction from the viewer during the viewer-played game to spawn an additional viewer-played game from the first viewer-played game.

In another aspect of the present invention the method further includes providing the viewer with control over a player who is not among the players in the broadcast game.

In another aspect of the present invention the method further includes providing the viewer with control over which players participate in the viewer-played game.

In another aspect of the present invention the method further includes controlling the performance of a player in a viewer-played game in accordance with the current performance statistics of a corresponding living player.

In another aspect of the present invention the method further includes providing multi-player game play of the viewer-played game.

In another aspect of the present invention the method further includes controlling the broadcast game with information from the viewer-played game.

In another aspect of the present invention a system is provided for extending a broadcast game into a viewer-played game, the system including a viewer-played game configured to provide interactive game play within a simulation of a broadcast game, and a processing unit configured to provide the broadcast game and the viewer-played game to a viewer.

In another aspect of the present invention the processing unit is configured to receive an instruction from the viewer during the broadcast game to initiate the viewer-played game.

In another aspect of the present invention the processing unit is configured to provide the broadcast game and the viewer-played game responsive to receiving the instruction.

In another aspect of the present invention the processing unit is configured to incorporate at least one characteristic of the broadcast game within the simulation, thereby creating a continuation of the broadcast game.

In another aspect of the present invention the system further includes a broadcast medium configured to convey a message announcing the availability of the viewer-played game play in connection with the broadcast game.

In another aspect of the present invention the processing unit is configured to accept payment from the viewer in connection with the viewer-played game.

In another aspect of the present invention the simulation has an initial state, where the initial state is based on a previous state of the broadcast game.

In another aspect of the present invention the simulation has an initial state, where the initial state is based on a current state of the broadcast game.

In another aspect of the present invention the processing unit is configured to suspend the providing of the broadcast game upon the providing of the viewer-played game, and resume the providing of the broadcast game upon cessation of the viewer-played game.

In another aspect of the present invention the processing unit is configured to provide the viewer-played game for a period of time generally equal to the time elapsed between a time corresponding to the previous state and a time during the broadcast when the viewer-played game was initiated.

In another aspect of the present invention the processing unit is configured to interrupt the broadcast game during the viewer-played game, buffer the broadcast game from the point of interruption, and resume the broadcast game from the point of interruption upon cessation of the viewer-played game.

In another aspect of the present invention the processing unit is configured to provide the broadcast game and the viewer-played game simultaneously.

In another aspect of the present invention the processing unit is configured to selectably switch between the broadcast game and the viewer-played game.

In another aspect of the present invention the processing unit is configured to receive a signal from the viewer requesting the switching.

In another aspect of the present invention the processing unit is configured to initialize the simulation from parameters of the broadcast game, where the parameters are derived from a digital broadcast stream carrying the broadcast game.

In another aspect of the present invention the processing unit is configured to modify a simulation parameter of the viewer-played game responsive to a modification of a corresponding real parameter of the broadcast game.

In another aspect of the present invention the processing unit is configured to determine when to modify the simulation parameter of the viewer-played game.

In another aspect of the present invention the processing unit is configured to receive a signal from the viewer indicating when to modify the simulation parameter of the viewer-played game.

In another aspect of the present invention the processing unit is configured to substitute a simulation parameter of the viewer-played game corresponding to a real parameter of the broadcast game with a different simulation parameter not corresponding to a real parameter of the broadcast game.

In another aspect of the present invention the processing unit is configured to receive an instruction from the viewer during the viewer-played game to spawn an additional viewer-played game from the first viewer-played game.

In another aspect of the present invention the processing unit is configured to provide the viewer with control over a player who is not among the players in the broadcast game.

In another aspect of the present invention the processing unit is configured to provide the viewer with control over which players participate in the viewer-played game.

In another aspect of the present invention the processing unit is configured to control the performance of a player in a viewer-played game in accordance with the current performance statistics of a corresponding living player.

In another aspect of the present invention the processing unit is configured to provide multi-player game play of the viewer-played game.

In another aspect of the present invention the processing unit is configured to control the broadcast game with information from the viewer-played game.

### BRIEF DESCRIPTION OF THE DRAWINGS

The present invention will be understood and appreciated more fully from the following detailed description taken in conjunction with the appended drawings in which:

FIG. 1 is a simplified conceptual flow illustration of a system for combining broadcast sporting events and computer-based gaming, constructed and operative in accordance with an embodiment of the present invention;

FIG. 2 is a simplified flowchart illustration of an exemplary method of operation of the system of FIG. 1, operative in accordance with an embodiment of the present invention;

FIGS. 3 and 4 are simplified block diagrams of various features and data flows of the system of FIG. 1, constructed and operative in accordance with an embodiment of the present invention; and

FIG. 5 is a simplified conceptual flow illustration of switching between a broadcast sporting event and a viewer-played game, constructed and operative in accordance with an embodiment of the present invention.

### DETAILED DESCRIPTION OF EMBODIMENTS OF THE INVENTION

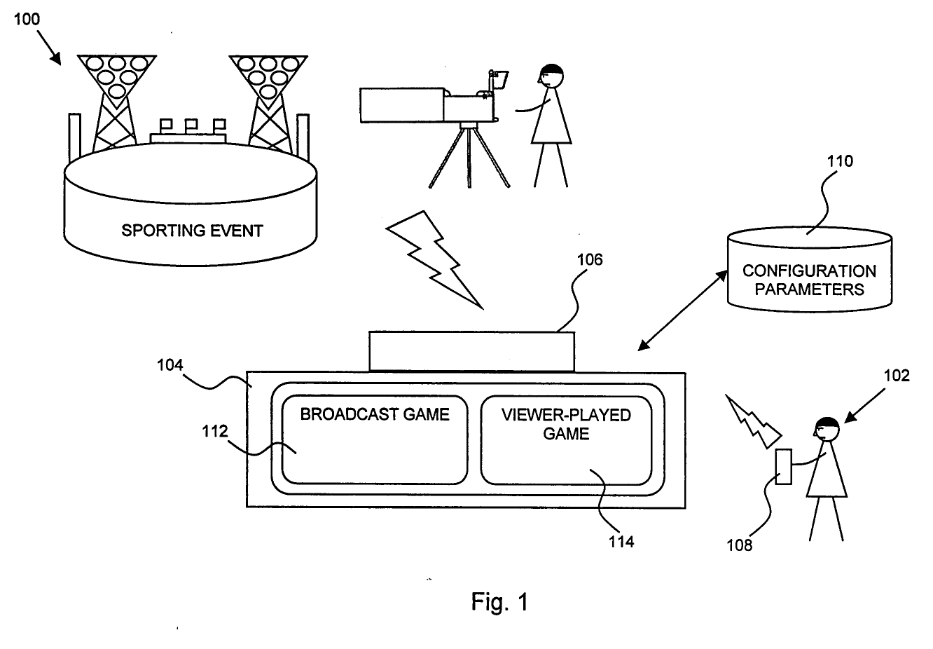

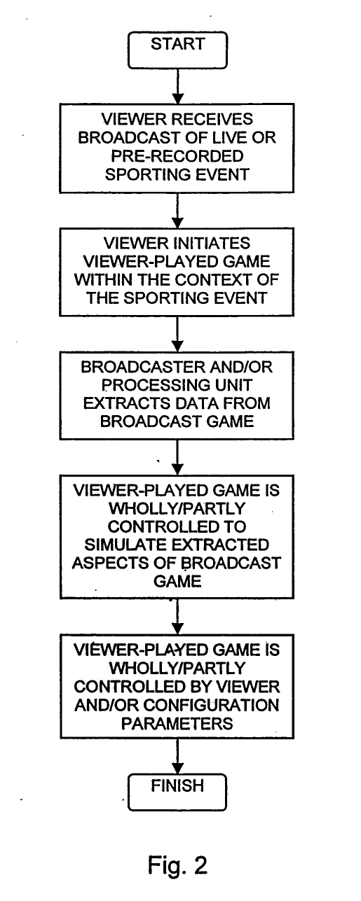

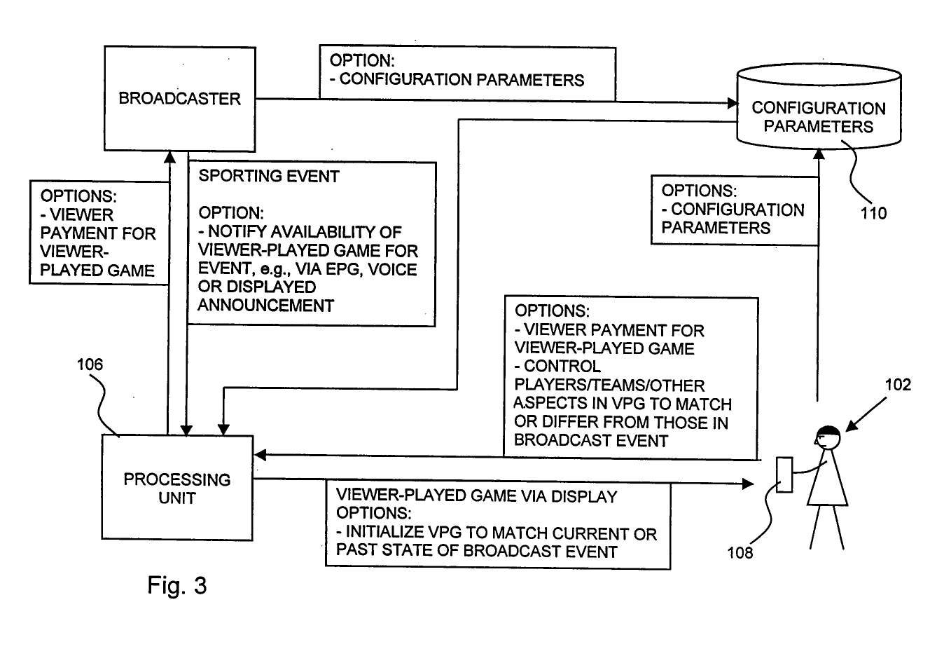

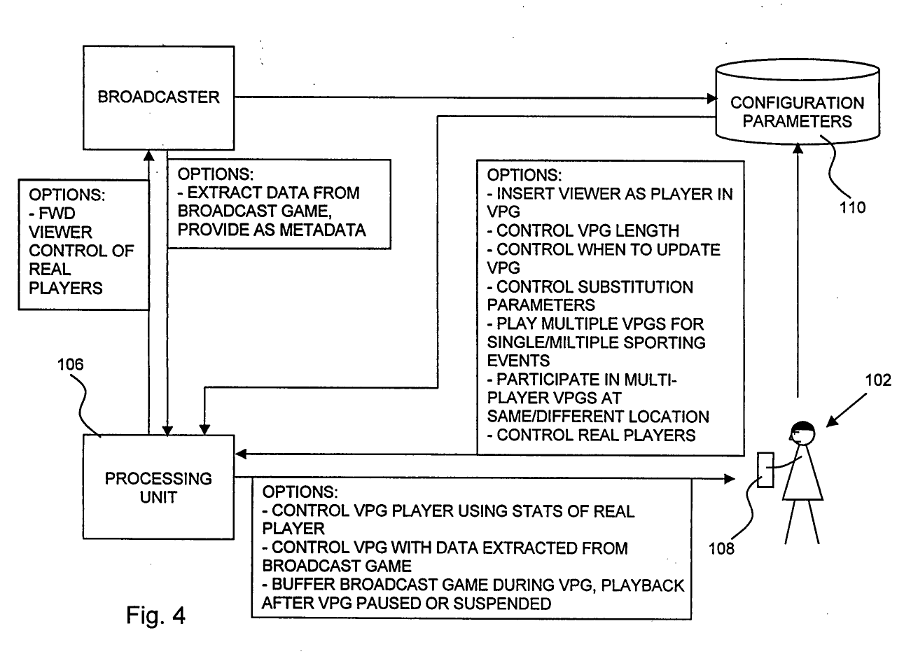

Reference is now made to FIG. 1, which is a simplified conceptual flow illustration of a system for combining broadcast sporting events and computer-based gaming, constructed and operative in accordance with an embodiment of the present invention, to FIG. 2, which is a simplified flowchart illustration of an exemplary method of operation of the system of FIG. 1, operative in accordance with an embodiment of the present invention, and additionally to FIGS. 3 and 4, which are simplified block diagrams of various features and data flows of the system of FIG. 1, constructed and operative in accordance with an embodiment of the present invention. A live or pre-recorded sporting event 100 is broadcast to a viewer 102 who views the event on a display 104, such as a television set or computer monitor. The broadcast may be provided using any broadcast medium, such as UHF/VHF, cable, or satellite transmission, and is received by a processing unit 106, such as a set-top box, which controls the display of the broadcast on display 104, and with which viewer 102 may interact, such as via a control unit 108.

During the broadcast of sporting event 100, viewer 102 may use control unit 108 to instruct processing unit 106 to initiate a viewer-played game (VPG) within the context of sporting event 100. The ability to initiate such a game may be available for any sporting event, or may only be available for specific sporting events, such as may be communicated in advance of and/or during the sporting event via a schedule or electronic program guide (EPG), or where the broadcaster sends an voice and/or display announcement to viewer 102 in advance of or during a sporting event that such gaming is available for the event, as well as instructions to that effect to processing unit 106. Furthermore, the initiation of a game may be contingent on the receipt of a payment from viewer 102 using any known viewer-based payment system, such as pay-per-view.

The initiation of a viewer-played game within the context of sporting event 100 results in the extension of the broadcast sporting into the viewer-played game in that the viewer-played game represents a simulation of the broadcast game where information about the broadcast game affects one or more aspects of the viewer-played game. For example, the teams and players participating in the viewer-played game may be configured to match those participating in the broadcast game. Similarly, specific broadcast game events, such as a goal scored by a team, may trigger corresponding events in the viewer-played game, such as a goal scored by the corresponding team in the viewer-played game. Viewer 102 may be given the option before or during an event to choose one or more players from those on the broadcast game's teams' rosters, or from other teams in the league to substitute in the viewer-played game on the viewer's chosen team. Where the viewer-played game is initiated while the broadcast game is in progress, the simulation of the broadcast game may be presented as a continuation of the broadcast game, reflecting the current state of the broadcast game at the point in the broadcast game when the viewer-played game is initiated. Broadcast game parameters and events may affect the viewer-played game exactly as they occur in the broadcast game, to a lesser extent, or not at all, in accordance with configuration parameters 110 set by the broadcaster, viewer 102, or both. The performance of a player in the viewer-played game may also be controlled in accordance with the current performance statistics of a corresponding living player. Configuration parameters 110 may also determine when the viewer-played game is updated with broadcast game parameters and events relative to when they occur within the broadcast, such as immediately or after a delay. Furthermore, one or more parameters of the broadcast game may be replaced with different parameters in the viewer-played game. For example, if a player in the broadcast game is represented by a player in the viewer-played game, and the player in the viewer-played game gets hurt and is benched in the viewer-played game but continues to play in the broadcast game, then every time the player plays in the broadcast real game a substitution may be provided for the player in the viewer-played game in place of the benched player. Additionally or alternatively, a viewer-played game may include one or more additional players not participating in the broadcast game, such as, for example, where viewer 102 controls a third bowler who competes against the two actual bowlers playing in a broadcast bowling tournament.

As an alternative to reflecting the current state of the broadcast game, the initial state of the viewer-played game may reflect a previous state of the broadcast game at a point earlier than the point in the broadcast game when the viewer-played game is initiated. In this instance, the viewer-played game may be played for as long as the user desires, or for a period of time generally equal to the time elapsed between the time of the previous state and the time during the broadcast game when the viewer-played game was begun. Thus, for example, the viewer-played game may begin at an earlier point in the broadcast game just prior to a poor play being committed, giving viewer 102 a chance to make a better play in the viewer-played game.

Information regarding the broadcast game that is used by the viewer-played game may be extracted by processing unit 106, by the broadcaster and provided as meta-data, or any combination thereof from the broadcast stream itself using conventional techniques, such as face recognition to identify players, optical character recognition to identify team names and venues, changes in score, penalty information, and other game play information that may appear as text overlay, and other image and pattern recognition techniques to identify ball movement, playing field boundaries, and other game elements. The extracted information is then used by control unit 108 to initialize and control the viewer-played game.

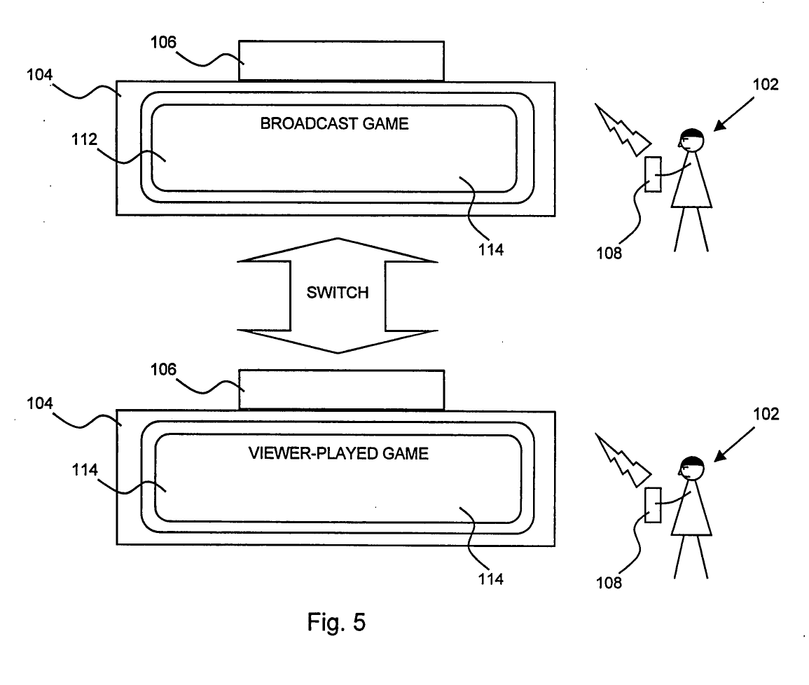

In addition to the broadcast game possibly affecting the viewer-played game, the viewer-played game provides viewer 102 with interactive game play in accordance with conventional gaming techniques. The viewer-played game may be displayed on display 104 in place of sporting event 100 or along side it, such as in a split screen where the broadcast game is seen on a portion 112 of display 104 and the viewer-played game is seen on a portion 114 of display 104. Where the viewer-played game is displayed on display 104 in place of sporting event 100, viewer 102 may use control unit 108 to instruct processing unit 106 to pause the viewer-played game and switch to the broadcast game, and vice versa, as shown in FIG. 5, with control unit 108 optionally buffering the broadcast game while the viewer-played game is being played, allowing for the broadcast game to be resumed either from the point where buffering began or at its current point. At any point during the viewer-played game viewer 102 may use control unit 108 to instruct processing unit 106 to quit the viewer-played game, whereupon the broadcast game returns to full-screen viewing on display 104 if it is still in progress.

Viewer 102 need not be limited to a single viewer-played game, but may initiate and switch between multiple viewer-played games to correspond to multiple sporting events being broadcast on multiple channels at the same time. Additionally or alternatively, viewer 102 may spawn multiple instances of a viewer-played game corresponding to the same broadcast game. Each viewer-played game may be initialized with broadcast game characteristics taken from different points during the broadcast game. Additionally or alternatively, viewer 102 may spawn one or more viewer-played games from a single viewer-played game, each spawned game copying the parameters of its parent at the time it is spawned, thereby enabling viewer 102 to employ different tactics from the same point in a viewer-played game.

A single viewer-played game may be played by multiple viewers, such as where each viewer controls a different team, at a single physical location, or where two viewer-played games played by two different viewers in two different physical locations are logically merged to allow for the viewers to compete against each other using conventional techniques for network-based multi-player games.

The present invention may also provide for interaction between the broadcast of a live sporting event and a viewer-played game corresponding to the live event, where information from the viewer-played game is applied to the live sporting event. For example, viewer 102 may be invited to control a player in the viewer-played game, such that any of the players actions in the viewer-played game may be communicated to the corresponding player in the live event, such as via an interactive television channel or other known communications means, and carried out by the live player.

It is appreciated that one or more of the steps of any of the methods described herein may be omitted or carried out in a different order than that shown, without departing from the true spirit and scope of the invention.

While the methods and apparatus disclosed herein may or may not have been described with reference to specific computer hardware or software, it is appreciated that the methods and apparatus described herein may be readily implemented in computer hardware or software using conventional techniques.

While the present invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

What is claimed is:

1. A method for extending a broadcast game into a viewer-played game, the method comprising:
a) providing a broadcast game to a viewer;
b) receiving an instruction from said viewer during said broadcast to provide a simulation of said broadcast game; and
c) providing a viewer-played game to said viewer, wherein said viewer-played game provides interactive game play within said simulation.

2. A method according to claim 1 wherein said providing of said viewer played game comprises providing a simulation of said broadcast game that incorporates at least one characteristic of said broadcast game, thereby creating a continuation of said broadcast game.

3. A method according to claim 1 and further comprising announcing the availability of said viewer-played game play in connection with said broadcast game.

4. A method according to claim 1 and further comprising accepting payment from said viewer in connection with said viewer-played game.

5. A method according to claim 1 wherein said simulation has an initial state, and wherein said initial state is based on a previous state of said broadcast game.

6. A method according to claim 1 wherein said simulation has an initial state, and wherein said initial state is based on a current state of said broadcast game.

7. A method according to claim 1 and further comprising:
suspending said providing of said broadcast game upon said providing of said viewer-played game; and
resuming said providing of said broadcast game upon cessation of said viewer-played game..

8. A method according to claim 5 wherein said providing of said viewer played game comprises providing said viewer-played game for a period of time generally equal to the time elapsed between a time corresponding to said previous state and a time during said broadcast when said instruction was received.

9. A method according to claim 1 and further comprising:
interrupting said broadcast game during said viewer-played game;
buffering said broadcast game from said point of interruption; and
resuming said broadcast game from said point of interruption upon cessation of said viewer-played game.

10. A method according to claim 1 wherein said providing said broadcast game and said providing said viewer-played game comprise providing said broadcast game and said viewer-played game simultaneously.

11. A method according to claim 1 and further comprising selectably switching between said broadcast game and said viewer-played game.

12. A method according to claim 11 and further comprising receiving a signal from said viewer requesting said switching.

13. A method according to claim 1 and further comprising initializing said simulation from parameters of said broadcast game, wherein said parameters are derived from a digital broadcast stream carrying said broadcast game.

14. A method according to claim 1 and further comprising modifying a simulation parameter of said viewer-played game responsive to a modification of a corresponding real parameter of said broadcast game.

15. A method according to claim 14 and further comprising determining when to modify said simulation parameter of said viewer-played game.

16. A method according to claim 15 and further comprising receiving a signal from said viewer indicating when to modify said simulation parameter of said viewer-played game.

17. A method according to claim 1 and further comprising substituting a simulation parameter of said viewer-played game corresponding to a real parameter of said broadcast game with a different simulation parameter not corresponding to a real parameter of said broadcast game.

18. A method according to claim 1 and further comprising receiving an instruction from said viewer during said viewer-played game to spawn an additional viewer-played game from said first viewer-played game.

19. A method according to claim 1 and further comprising providing said viewer with control over a player who is not among the players in said broadcast game.

20. A method according to claim 1 and further comprising providing said viewer with control over which players participate in said viewer-played game.

21. A method according to claim 1 and further comprising controlling the performance of a player in a viewer-played game in accordance with the current performance statistics of a corresponding living player.

22. A method according to claim 1 and further comprising providing multi-player game play of said viewer-played game.

23. A method according to claim 1 and further comprising controlling said broadcast game with information from said viewer-played game.

24. A system for extending a broadcast game into a viewer-played game, the system comprising:
a viewer-played game configured to provide interactive game play within a simulation of a broadcast game; and
a processing unit configured to provide said broadcast game and said viewer-played game to a viewer.

25. A system according to claim 24 wherein said processing unit is configured to receive an instruction from said viewer during said broadcast game to initiate said viewer-played game.

26. A system according to claim 24 wherein said processing unit is configured to provide said broadcast game and said viewer-played game responsive to receiving said instruction.

27. A system according to claim 24 wherein said processing unit is configured to incorporate at least one characteristic of said broadcast game within said simulation, thereby creating a continuation of said broadcast game.

28. A system according to claim 24 and further comprising a broadcast medium configured to convey a message announcing the availability of said viewer-played game play in connection with said broadcast game.

29. A system according to claim 24 wherein said processing unit is configured to accept payment from said viewer in connection with said viewer-played game.

30. A system according to claim 24 wherein said simulation has an initial state, and wherein said initial state is based on a previous state of said broadcast game.

31. A system according to claim 24 wherein said simulation has an initial state, and wherein said initial state is based on a current state of said broadcast game.

32. A system according to claim 24 wherein said processing unit is configured to:
suspend said providing of said broadcast game upon said providing of said viewer-played game, and
resume said providing of said broadcast game upon cessation of said viewer-played game.

33. A system according to claim 30 wherein said processing unit is configured to provide said viewer-played game for a period of time generally equal to the time elapsed between a time corresponding to said previous state and a time during said broadcast when said viewer-played game was initiated.

34. A system according to claim 24 wherein said processing unit is configured to:
interrupt said broadcast game during said viewer-played game;
buffer said broadcast game from said point of interruption; and
resume said broadcast game from said point of interruption upon cessation of said viewer-played game.

35. A system according to claim 24 wherein said processing unit is configured to provide said broadcast game and said viewer-played game simultaneously.

36. A system according to claim 24 wherein said processing unit is configured to selectably switch between said broadcast game and said viewer-played game.

37. A system according to claim 36 wherein said processing unit is configured to receive a signal from said viewer requesting said switching.

38. A system according to claim 24 wherein said processing unit is configured to initialize said simulation from parameters of said broadcast game, wherein said parameters are derived from a digital broadcast stream carrying said broadcast game.

39. A system according to claim 24 wherein said processing unit is configured to modify a simulation parameter of said viewer-played game responsive to a modification of a corresponding real parameter of said broadcast game.

40. A system according to claim 39 wherein said processing unit is configured to determine when to modify said simulation parameter of said viewer-played game.

41. A system according to claim 40 wherein said processing unit is configured to receive a signal from said viewer indicating when to modify said simulation parameter of said viewer-played game.

42. A system according to claim 24 wherein said processing unit is configured to substitute a simulation parameter of said viewer-played game corresponding to a real parameter of said broadcast game with a different simulation parameter not corresponding to a real parameter of said broadcast game.

43. A system according to claim 24 wherein said processing unit is configured to receive an instruction from said viewer during said viewer-played game to spawn an additional viewer-played game from said first viewer-played game.

44. A system according to claim 24 wherein said processing unit is configured to provide said viewer with control over a player who is not among the players in said broadcast game.

45. A system according to claim 24 wherein said processing unit is configured to provide said viewer with control over which players participate in said viewer-played game.

46. A system according to claim 24 wherein said processing unit is configured to control the performance of a player in a viewer-played game in accordance with the current performance statistics of a corresponding living player.

47. A system according to claim 24 wherein said processing unit is configured to provide multi-player game play of said viewer-played game.

48. A system according to claim 24 wherein said processing unit is configured to control said broadcast game with information from said viewer-played game.
